(19) United States
(12) Patent Application Publication
(10) Pub. No.: US 2020/0355957 A1
(43) Pub. Date: Nov. 12, 2020

(54) DISPLAY DEVICE, DISPLAY AND METHOD OF COMBINING DISPLAY PANEL WITH BACKLIGHT MODULE

(71) Applicants: HKC CORPORATION LIMITED, Shenzhen, Guangdong (CN); CHONGQING HKC OPTOELECTRONICS TECHNOLOGY CO., LTD., Chongqing (CN)

(72) Inventor: Jia-He CHENG, Chongqing (CN)

(21) Appl. No.: 16/640,514

(22) PCT Filed: Dec. 13, 2017
(86) PCT No.: PCT/CN2017/115902

§ 371 Date: Feb. 20, 2020

(30) Foreign Application Priority Data
Aug. 22, 2017 (CN) 201710725375.8

(51) Int. Cl. G02F 1/1333; G02F 1/13357

(52) U.S. Cl. CPC G02F 1/133308; G02F 2201/46; G02F 2001/133325; G02F 1/133608

(57) ABSTRACT

A display device, display, and method for assembling display panel with backlight module are provided. The display device comprises a backlight module and a display panel. The backlight module comprises a back cover and a backlight system. The back cover supports the backlight system. The back cover comprises a protrusion positioned at one side of the back cover. A height of the backlight system is less than or equal to that of the protrusion. A first magnetic material is coated on or embedded in a surface of the protrusion. A second magnetic material is coated on or embedded in a surface of a substrate of the display panel and positioned at one side of the display panel. The first and second magnetic materials are attracted to each other. The second magnetic material is disposed corresponding to the first magnetic material to fix the display panel to the backlight module.

### BACKGROUND

### Technical Field

This disclosure relates to a technical field of a display device, and more particularly to a display device, a display and a method for assembling a display panel with a backlight module.

### Related Art

Most of the current display devices comprise front bezels or frames for mounting display panels and backlight modules. Such configurations usually result in that the appearances of the display devices are not stylish and beautiful.

Currently some frameless display devices are still available in the market. Such frameless display device generally uses double-sided tapes to bond and fix the display panel to the backlight module. Alternatively, the bonding and fixing of the display panel and the backlight modules are carried out via coating liquid glues on corresponding bonding portions of the display panel and the backlight module, followed by attaching and drying. The adhesion between the display panel and the backlight module provided by the liquid glues or the double-sided tapes may usually diminished after a long-term use or under a high-temperature and high-humidity condition, such that the display panel and the backlight module may be then fixed to each other very well.

### SUMMARY

The disclosure provides a display device, a display, and a method for assembling a display panel with a backlight module, and the display panel and the backlight module are fixed via a magnetic force exerted from two opposite magnetic poles which attract each other, so as to form a frameless display device.

In one aspect, the disclosure provides a display device, which includes a backlight module and a display panel. The backlight module comprises a back cover and a backlight system. The back cover supports the backlight system. The back cover comprises a protrusion which is positioned at one side of the back cover. A height of the backlight system is less than or equal to a height of the protrusion. A first magnetic material is coated on or embedded in a surface of the protrusion. The display panel comprises a substrate. A second magnetic material is coated on or embedded in a surface of the substrate and is positioned at one side of the substrate. The second magnetic material is disposed corresponding to the first magnetic material such that the first and second magnetic materials are attracted to each other, so as to fix the display panel to the backlight module.

Furthermore, the protrusion of the back cover comprises a protruding portion. The protruding portion protrudes away from the backlight system, and the first magnetic material is coated on or embedded in a surface of the protruding portion.

Furthermore, one side of the backlight system is attached to a lateral surface of the protrusion.

Furthermore, the side of the backlight module which the first magnetic material is coated on or embedded in is aligned with the side of the display panel which the second magnetic material is coated on or embedded in.

Furthermore, another side of the backlight system is aligned with another side of the display panel.

Furthermore, the first magnetic material and the second magnetic material are both ferromagnetic plates.

Furthermore, a buffer layer is disposed between the backlight module and the display panel to separate the display panel from the backlight module.

In another aspect, the disclosure provides a display, which includes a display device, a housing and a base. The housing fixes the display device, and the base is for placing the display on a plane firmly. The display device comprises a backlight module, a display panel and a driving circuitry. The backlight module comprises a back cover and a backlight system. The back cover supports the backlight system. The back cover has a protrusion which is positioned at one sided of the back cover. A height of the backlight system is less than or equal to a height of the protrusion. A first magnetic material is coated on or embedded in a surface of the protrusion. The display panel comprises a substrate. A second magnetic material is coated on or embedded in a surface of the substrate and is positioned at one side of the substrate. The second magnetic material is disposed corresponding to the first magnetic material such that the first and second magnetic materials are attracted to each other, so as to fix the display panel to the backlight module. The driving circuitry comprises a scan-line driving circuit and a data-line driving circuit. The scan-line driving circuit and the data-line driving circuit are respectively coupled to scan lines and data lines disposed on the substrate of the display panel and respectively drive the scan lines and the data lines. The substrate comprises a first glass substrate, and the second magnetic material is coated on or embedded in a surface of the first glass substrate.

In yet another aspect, the disclosure also provides a method for assembling a display panel with a backlight module. The method comprises the following steps: coating or embedding a first magnetic material on or in a surface of a protrusion of a back cover of the backlight module, and the protrusion is positioned at one side of the back cover; coating or embedding a second magnetic material which is attracted to the first magnetic material on or in one side of a surface of a substrate of the display panel, and said side of the surface of the substrate is corresponding to where the first magnetic material is coated or embedded; and, placing the display panel against the backlight module such that the second magnetic material is disposed corresponding to the first magnetic material and that the second magnetic material and the first magnetic material are attracted to each other, so as to fix the display panel to the backlight module.

Furthermore, during placing the display panel against the backlight module such that the second magnetic material is disposed corresponding to the first magnetic material, the method comprises the following steps: along an edge of a lateral stopper plate, placing the side of the backlight module which the first magnetic material is coated on or embedded in upwards; and, along the edge of the lateral stopper plate, placing the side of the display panel which the second magnetic material is coated on or embedded in downwards and aligning said side of the display panel with the side of the backlight module which the first magnetic material is coated on or embedded in, such that the second magnetic material of the display panel is disposed corresponding to the first magnetic material of the backlight module.

Furthermore, during placing the display panel against the backlight module such that the second magnetic material is disposed corresponding to the first magnetic material, the method comprises the following steps: along an edge of a lateral stopper plate, placing the side of the display panel which the second magnetic material is coated on or embedded in and the display panel is placed upwards; and, along the edge of the lateral stopper plate, placing the side of the backlight module which the first magnetic material is coated on or embedded in and aligning said side of the backlight module with the side of the display panel which the second magnetic material is coated on or embedded in, and the backlight module is placed downwards, such that the first magnetic material of the backlight module is disposed corresponding to the second magnetic material of the display panel.

Furthermore, the method for assembling a display panel with a backlight module further comprises the following step: disposing a buffer layer between the backlight module and the display panel to separate the display panel from the backlight module.

This disclosure provides a display device, a display and a method for assembling the display panel with a backlight module. The magnetic materials which are attracted to each other are coated on or embedded in the corresponding portions of the display panel and the backlight module respectively, and, hence, the display panel and the backlight module are fixed via a magnetic force exerted from two opposite magnetic poles which attract each other, so as to form a frameless display device.

### BRIEF DESCRIPTION OF THE DRAWINGS

The embodiments will become more fully understood from the detailed description and accompanying drawings, which are given for illustration only, and thus are not limitative of the present invention, and wherein:

FIG. 1 is a schematic structural view showing a display device provided by an embodiment of this disclosure;

FIG. 2 is a schematic structural view showing a display provided by an embodiment of this disclosure; and

FIG. 3 is a schematic flow chart showing a method for assembling a display panel with a backlight module provided by an embodiment of this disclosure.

### DETAILED DESCRIPTION OF THE INVENTION

Specific structures and function details disclosed herein are only for the illustrative purpose for describing the exemplary embodiment of this disclosure. However, this disclosure can be specifically implemented through many replacements, and should not be explained as being restricted to only the embodiment disclosed herein.

The terms used herein are for the purpose of describing only specific embodiments and are not intended to limit the exemplary embodiments. Unless the contexts clearly indicate otherwise, it should be understood that the terms “comprising” and/or “including” are used herein to describe the features to describe the presence of stated features, integers, steps, operations, units and/or elements without excluding the presence or addition of one or more other features, integers, steps, operations, units, elements, and/or combinations thereof.

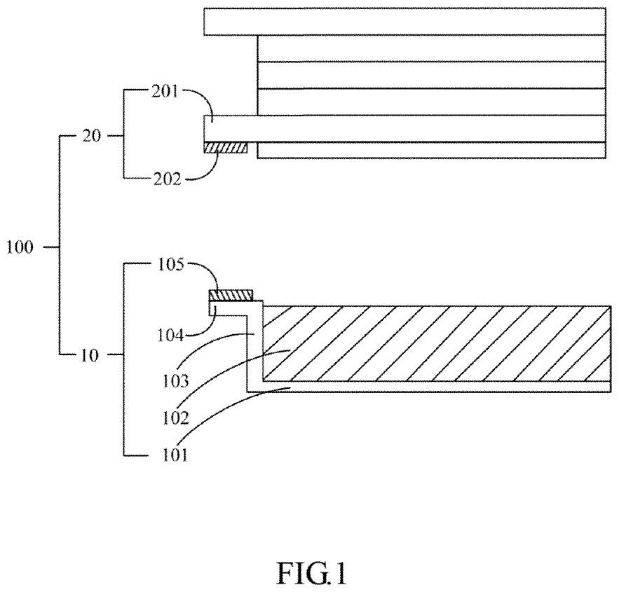

Referring to FIG. 1, a display device 100 is provided according to an embodiment of this disclosure. The display device 100 includes a backlight module 10 and a display panel 20.

The backlight module 10 includes a back cover 101 and a backlight system 102. The back cover 101 supports the backlight system 102. The back cover 101 comprises a protrusion 103 which is positioned at one side of the back cover. A height of the backlight system 102 is less than or equal to a height of the protrusion 103. A first magnetic material 105 is coated on or embedded in a surface of the protrusion 103.

The display panel 20 in the display device generally comprises an array substrate, an upper polarizer, a lower polarizer, an upper substrate, and a lower substrate, etc. In the existing technology, when a person is watching the display device, the backlight module 10 is the farthest part away from the viewer among the components of the display device. The polarizer which is closer to the backlight module 10 is named as the lower polarizer, and the polarizer which is closer to the viewer is named as the upper polarizer. The substrate which is closer to the backlight module 10 is named as the lower substrate, and the substrate which is closer to the viewer is named as the upper substrate. The display panel 20 pertains to the existing technology, so detailed descriptions will be omitted here.

Furthermore, the substrate can be a glass substrate, and comprise a first glass substrate (i.e., a lower glass substrate) and a second glass substrate (i.e., an upper glass substrate).

A second magnetic material 202 is coated on or embedded in a surface of a substrate 201 of the display panel 20 and is positioned at one side of the substrate 201. The first magnetic material 105 and the second magnetic material 202 are configured to be attracted to each other. The second magnetic material 202 is disposed corresponding to the first magnetic material 105 such that the first magnetic material 105 and the second magnetic material 202 are attracted to each other, so as to fix the display panel 20 to the backlight module.

The terms “first” and “second” in the embodiment of this disclosure are only used for distinguishing the magnetic materials from each other without restricting the properties of the magnetic materials. In the embodiment of this disclosure, the magnetic material can be a ferromagnetic plate.

Furthermore, the magnetic material can be coated on or embedded in the lower surface (i.e., the surface which faces toward the illuminating surface of the backlight module 10) of the second glass substrate of the display panel (or coated on or embedded in the upper surface of the second glass substrate. Alternatively, the magnetic material can be coated on or embedded in the lower and upper surfaces of the second glass substrate both.

The backlight module 10 and the display panel 20 are fixed via the magnetic materials which are attracted to each other, and a bezel is no longer necessary. Via such configuration the display device 100 may be formed as a frameless display, so that the appearance of the display device 100 is stylish and beautiful.

In some embodiments, the display panel can be a Twisted Nematic panel (TN panel), an In-Plane Switching panel (IPS panel), a Vertical Alignment panel (VA panel), a Multi-domain Vertical Alignment panel (MVA panel), a Continuous Pinwheel Alignment panel (CPA panel), an Advanced Super Dimension Switch panel (ADSDS panel), a liquid crystal display panel, a Light-Emitting Diode panel (LED panel), an Organic Light-Emitting Diode panel (OLED panel), a Quantum Dot Light-Emitting Diode panel (QLED panel), a curved panel, or any other suitable panels.

In one embodiment of this disclosure, the protrusion 103 of the back cover 101 has a protruding portion 104. The protruding portion 104 protrudes away from the backlight system 102, and the first magnetic material 105 is coated on or embedded in the surface of the protruding portion 104.

The protruding portion 104 is provided as a portion to be fixed with the display panel 20, such that the backlight module 10 can be conveniently fixed to the display panel 20.

In one embodiment of this disclosure, one side of the backlight system 102 is attached to one lateral surface of the protrusion 103.

In one embodiment of this disclosure, the side of the backlight module 10 which the first magnetic material 105 is coated on or embedded in is aligned with the side of the display panel 20 which the second magnetic material 202 is coated on or embedded in.

In one embodiment of this disclosure, another side of the backlight system 102 is aligned with another side of the display panel 20.

The backlight system 102 is aligned with two sides of the display panel 20, so that the display device 100 becomes more beautiful.

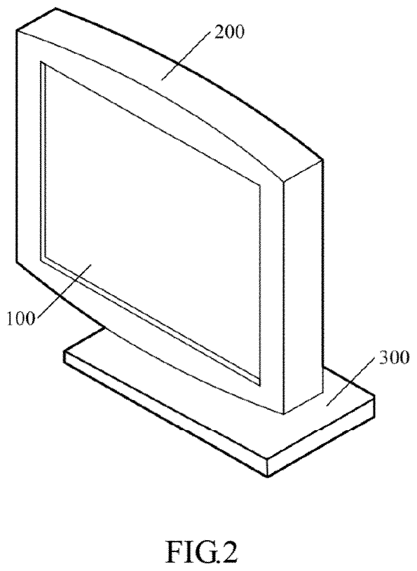

FIG. 2 is a display provided by one embodiment of this disclosure. Referring to FIG. 2, the display comprises the display device 100, a housing 200 for fixing the display device 100, and a base 300 for placing the display on the plane firmly.

Furthermore, the display device 100 comprises a backlight module, a display panel and a driving circuitry to drive the display panel.

In one embodiment of this disclosure, the backlight module comprises a backlight system and a back cover. The back cover supports the backlight system. The back cover comprises a protrusion which is positioned at one side of the back cover. A height of the backlight system is less than or equal to a height of the protrusion. A first magnetic material is coated on or embedded in a surface of the protrusion.

The display panel comprises a substrate. A second magnetic material is coated on or embedded in a surface of the substrate and is positioned at one side of the substrate. The first and second magnetic materials are configured to be able to attract each other. The second magnetic material is disposed corresponding to the first magnetic material such that the second magnetic material and the first magnetic material are attracted to each other, so as to fix the display panel to the backlight module.

Furthermore, the substrate comprises a first glass substrate, and the second magnetic material is coated on or embedded in the surface of the first glass substrate. The first glass substrate is the lower glass substrate of the display panel.

The driving circuitry comprises a scan-line driving circuit and a data-line driving circuit, which are respectively coupled to scan lines and data lines disposed on the substrate of the display panel and respectively drive the scan lines and the data lines.

More specific descriptions of the display device 100 in this embodiment of this disclosure may be found in the aforementioned embodiment, so detailed descriptions will be omitted here.

For the display provided the embodiment of this disclosure, because the display device 100 does not comprises a bezel, the display can be made thinner when the display device 100 is manufactured to become the display.

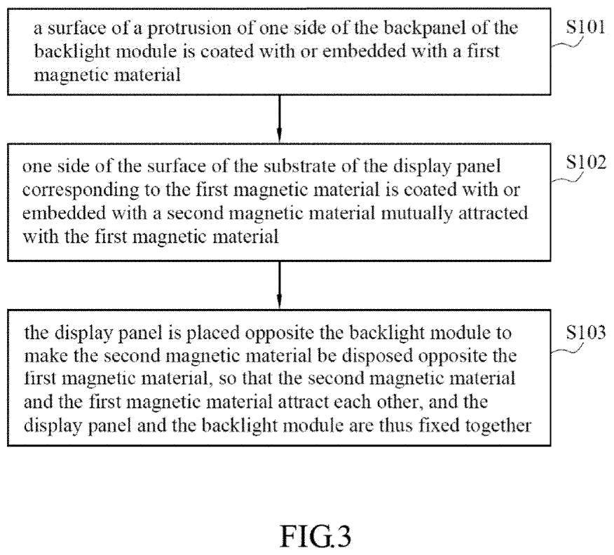

FIG. 3 is a method for assembling a display panel with a backlight module provided by one embodiment of this disclosure. As shown in FIG. 3, the display panel and the backlight module are the display panel and the backlight module described in the aforementioned embodiment. The method for assembling the display panel with the backlight module comprises the following steps S101 to S103.

In the step S101, a first magnetic material is coated on or embedded in a surface of a protrusion which is positioned at one side of the back cover of the backlight module.

In the step S102, a second magnetic material is coated on or embedded in a surface of the substrate of the display panel and positioned at one side of the substrate. The second magnetic material is disposed corresponding to the first magnetic material. The first and the second magnetic materials are configured to be able to attract each other.

Before the display panel is assembled to the backlight module, it is necessary to coat or embed the magnetic materials, which are able to attract each other, such as ferromagnetic plates, on or in the portions of both components where to be fixed and in contact with each other respectively.

In other embodiments, the magnetic materials may be in other types or structures.

In the step S103, the display panel is placed against the backlight module such that the second magnetic material is disposed corresponding to the first magnetic material and that the second magnetic material and the first magnetic material are attracted to each other, so as to fix the display panel to the backlight module.

The display panel and the backlight module which are coated with or embedded with mutually attracted magnetic materials are attached to each other, such that the two magnetic materials are disposed corresponding to each other. Through attraction forces exerted by the magnetic materials, the display panel and the backlight module are attracted and fixed to each other.

By the aforementioned method, it is not necessary to use the bezel to fix the display panel and the backlight module, and a frameless display device can be assembled.

Furthermore, in the step S103, during placing the display panel against the backlight module such that the second magnetic material is disposed corresponding to the first magnetic material, the method comprises the following steps.

The side of the backlight module which the first magnetic material is coated on or embedded in is placed upwards and along an edge of a lateral stopper plate. Later, the side of the display panel which the second magnetic material is coated on or embedded in is placed downwards and along the edge of the lateral stopper plate, and said side of the display panel is aligned with the side of the backlight module which the first magnetic material is coated on or embedded in. In such manner, the second magnetic material of the display panel is disposed corresponding to the first magnetic material of the backlight module.

Furthermore, after the side of the backlight module which the first magnetic material is coated on or embedded in is placed upwards along the edge of the side stopper plate, a buffer layer is placed on the surface of the backlight module. Then, the side of the display panel which the second magnetic material is coated on or embedded in is placed downwards and to align with the side of the backlight module which the first magnetic material is coated on or embedded in along the edge of the lateral stopper plate. In such manner, the buffer layer separates the display panel from the backlight module, so as to prevent the display panel from colliding with the backlight module.

In one embodiment of this disclosure, the buffer layer can be a thin sponge gasket.

In some embodiments, in the step S103, during placing the display panel against the backlight module such that the second magnetic material is disposed corresponding to the first magnetic material, the method comprises the following steps. The side of the display panel which the second magnetic material is coated on or embedded in is placed upwards along an edge of a side stopper plate. Later, along the edge of the side stopper plate, the side of the backlight module which the first magnetic material is coated on or embedded in is placed downwards and aligned, with the side of the display panel which the second magnetic material is coated on or embedded in. In such manner, the first magnetic material of the backlight module is disposed corresponding to the second magnetic material of the display panel.

Furthermore, after the side of the display panel which the second magnetic material is coated on or embedded in is placed upwards along the edge of the side stopper plate, a buffer layer is placed on the surface of the display panel. Later, along the edge of the side stopper plate, the side of the backlight module which the first magnetic material is coated on or embedded in is placed downwards and aligned with the side of the display panel which the second magnetic material is coated on or embedded in. In such manner, the buffer layer separates the display panel from the backlight module, so as to prevent the display panel from colliding with the backlight module.

In the assembling method of this disclosure, the display panel can be placed first, followed by placing the backlight module onto the display panel. Alternatively, the backlight module can be placed first, followed by placing the display panel onto the backlight module. The side stopper plate used herein provides a function for aligning the backlight module with the display panel.

In the method for assembling the display panel with a backlight module of the disclosure, the display panel and the backlight module are fixed to each other via attraction force exerted by the opposite magnetic poles, so as to form a frameless display device.

It should be noted that, in the above embodiments, the descriptions of the respective embodiments are focused on their own characteristic portions which may not be described in detail in some or other embodiments. Those parts which is omitted in one embodiment can be referenced to the descriptions of other embodiments.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A display device, comprising:
a backlight module comprising a back cover and a backlight system, wherein the back plate supports the backlight system, the back cover comprises a protrusion positioned at one side of the back cover, a height of the backlight system is less than or equal to a height of the protrusion, and a first magnetic material is coated on or embedded in a surface of the protrusion; and
a display panel comprising a substrate, wherein a second magnetic material is coated on or embedded in a surface of the substrate and positioned at one side of the substrate, and the second magnetic material is disposed corresponding to the first magnetic material such that the first and second magnetic materials are attracted by each other, so as to fix the display panel to the backlight module.

2. The display device according to claim 1, wherein the protrusion of the back cover comprises a protruding portion, the protruding portion protrudes away from the backlight system, and the first magnetic material is coated on or embedded in a surface of the protruding portion.

3. The display device according to claim 1, wherein one side of the backlight system is attached to a lateral surface of the protrusion.

4. The display device according to claim 3, wherein the side of the backlight module which the first magnetic material is coated on or embedded in is aligned with said side of the display panel which with the second magnetic material is coated on or embedded in.

5. The display device according to claim 4, wherein another side of the backlight system is aligned with another side of the display panel.

6. The display device according to claim 1, wherein the first magnetic material and the second magnetic material are both ferromagnetic plates.

7. The display device according to claim 1, wherein a buffer layer is disposed between the backlight module and the display panel to separate the display panel from the backlight module.

8. A display, comprising:
a display device;
a housing for fixing the display device; and
a base for placing the display on a plane firmly;
wherein the display device comprises:
a backlight module comprising a back cover and a backlight system, wherein the back cover supports the backlight system, the back cover comprises a protrusion which is positioned at one side of the back cover, a height of the backlight system is less than or equal to a height of the protrusion, and a first magnetic material is coated on or embedded in a surface of the protrusion;
a display panel comprising a substrate, wherein a second magnetic material is coated on or embedded in a surface of the substrate and is positioned at one side of the substrate, the second magnetic material is disposed corresponding to the first magnetic material such that the first and second magnetic materials are attracted to each other, so as to fix the display panel to the backlight module; and
a driving circuitry comprising a scan-line driving circuit and a data-line driving circuit, wherein the scan-line driving circuit and the data-line driving circuit are respectively coupled to scan lines and data lines disposed on the substrate of the display panel so as to drive the scan lines and the data lines respectively;
wherein the substrate comprises a first glass substrate, and the second magnetic material is coated on or embedded in a surface of the first glass substrate.

9. The display according to claim 8, wherein the protrusion of the back cover comprises a protruding portion, the protruding portion protrudes away from the backlight system, and the first magnetic material is coated on or embedded in a surface of the protruding portion.

10. The display according to claim 8, wherein one side of the backlight system is bonded to a lateral surface of the protrusion.

11. The display according to claim 10, wherein one side of the backlight module which the first magnetic material is coated on or embedded in is aligned with said side of the display panel which the second magnetic material is coated on or embedded in.

12. The display according to claim 11, wherein another side of the backlight system is aligned with another side of the display panel.

13. The display according to claim 11, wherein the first magnetic material and the second magnetic material are both ferromagnetic plates.

14. The display according to claim 8, wherein a buffer layer is disposed between the backlight module and the display panel to separate the display panel from the backlight module.

15. A method for assembling a display panel with a backlight module, comprising:
coating or embedding a first magnetic material on or in a surface of a protrusion of a back cover of the backlight module, wherein the protrusion is positioned at one side of the back cover;
coating or embedding a second magnetic material which is attracted to the first magnetic material on or in one side of a surface of a substrate of the display panel, wherein said side of the surface of the substrate is corresponding to where the first magnetic material is coated or embedded; and
placing the display panel against the backlight module such that the second magnetic material is disposed corresponding to the first magnetic material and that the second magnetic material and the first magnetic material are attracted to each other, so as to fix the display panel to the backlight module.

16. The method according to claim 15, wherein during placing the display panel against the backlight module such that the second magnetic material is disposed corresponding to the first magnetic material, the method comprises:
along an edge of a lateral stopper plate, placing the side of the backlight module which the first magnetic material is coated on or embedded in upwards; and
along the edge of the lateral stopper plate, placing the side of the display panel which the second magnetic material is coated on or embedded in downwards and aligning said side of the display panel with the side of the backlight module which the first magnetic material is coated on or embedded in, such that the second magnetic material of the display panel is disposed corresponding to the first magnetic material of the backlight module.

17. The method according to claim 15, wherein during placing the display panel against the backlight module such that the second magnetic material is disposed corresponding to the first magnetic material, the method comprises:
along an edge of a lateral stopper plate, placing the side of the display panel which the second magnetic material is coated on or embedded in upwards; and
along the edge of the lateral stopper plate, placing the side of the backlight module which the first magnetic material is coated on or embedded in downwards and aligning said side of the backlight module with the side of the display panel which the second magnetic material is coated on or embedded in, such that the first magnetic material of the backlight module is disposed corresponding to the second magnetic material of the display panel.

18. The method according to claim 15, further comprising:
disposing a buffer layer between the backlight module and the display panel to separate the display panel from the backlight module.

19. The method according to claim 15, wherein the protrusion of the back cover comprises a protruding portion, and the first magnetic material is coated on or embedded in a surface of the protruding portion.

20. The method according to claim 15, wherein the first magnetic material and the second magnetic material are both ferromagnetic plates.
